(19) United States
(12) Patent Application Publication
(10) Pub. No.: US 2026/0227761 A1
(43) Pub. Date: Aug. 6, 2026

(54) DATA-DRIVEN ADDITIVE MANUFACTURING - COMPRESSION MOLDING

(71) Applicant: UT-Battelle, LLC, Oak Ridge, TN (US)

(72) Inventors: Ahmed A. Hassen, Knoxville, TN (US); Vipin Kumar, Knoxville, TN (US); Vlastimil Kunc, Knoxville, TN (US); Segun I. Talabi, Knoxville, TN (US); Brittany Rodriguez, Knoxville, TN (US); Komal Chawla, Knoxville, TN (US); Uday K. Vaidya, Knoxville, TN (US); Abdallah Ragab Barakat, Knoxville, TN (US); Berin Seta, Oak Ridge, TN (US); Jon Spangenberg, Oak Ridge, TN (US)

(21) Appl. No.: 19/464,863

(22) Filed: Jan. 30, 2026

Related U.S. Application Data
(60) Provisional application No. 63/752,550, filed on Jan. 31, 2025.

(51) Int. Cl. G05B 19/4099; B29C 43/58; B29C 64/393; B29C 69/02; B33Y 10/00; B33Y 40/00; B33Y 50/02

(52) U.S. Cl. CPC G05B 19/4099; B29C 43/58; B29C 64/393; B29C 69/02; B33Y 10/00; B33Y 40/00; B33Y 50/02; B29C 2043/5808; B29C 2043/5816; G05B 2219/49023

(57) ABSTRACT

The present invention provides a data-driven additive manufacturing (AM)—compression molding (CM) process in which a fiber-reinforced thermoplastic is deposited into a mold cavity and subsequently consolidated under heat and pressure. Deposition and molding parameters are selected using a numerical model to control microstructural characteristics and final part performance. Measured process data is fed to a control system to update the numerical model in real time. The control system is further configured to modify at least one AM or CM parameter based on a deviation between the measured process data and a model-predicted microstructural state. AM process parameters can include material flow rate, print speed, nozzle geometry, nozzle-to-substrate gap height, or material extrusion temperature. CM process parameters can include compression pressure, mold temperature, and compression timing after deposition.

### CROSS-REFERENCE TO RELATED APPLICATIONS

This application claims the benefit of U.S. Provisional Application 63/752,550, filed Jan. 31, 2025, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

Additive Manufacturing (AM) techniques have gained widespread adoption for producing complex geometries across a wide range of industries. In the context of polymer and fiber-reinforced materials, AM enables localized control over material placement and, to some extent, fiber orientation. However, AM processes alone suffer from inherent limitations, including relatively high porosity, incomplete interlayer fusion, and residual stresses. These issues can become pronounced in high-rate or large-format manufacturing. As a result, components produced solely through AM may require conservative design margins and significant post-processing.

Compression Molding (CM) is a well-established manufacturing process for composite materials. CM is widely used in high-volume production environments due to its ability to produce parts with low void content, good surface finish, and excellent dimensional stability. CM offers limited control over local fiber orientation, however. While CM can reduce defects such as porosity, it does not inherently provide the design flexibility or spatial control afforded by additive deposition techniques.

Hybrid approaches that combine AM with CM can leverage the advantages of both processes. Although some hybrid AM-CM approaches have shown promise in improving part quality and performance, existing systems often rely on trial-and-error parameter selection. Accordingly, there remains a continued need for an improved method and system that enables precise, data-driven control of process parameters, microstructure development, and final part performance in hybrid AM-CM manufacturing. Addressing these challenges can enable more reliable, efficient, and performance-optimized manufacturing of advanced composite structures.

### SUMMARY OF THE INVENTION

The present invention relates to methods for manufacturing fiber-reinforced composite articles using a hybrid additive manufacturing (AM) and compression molding (CM) process. The disclosed methods enable control of microstructural characteristics, including fiber orientation and porosity, through either real-time, in situ adjustment of process parameters or through a predictive modeling workflow performed prior to fabrication. By integrating AM and CM within a unified manufacturing framework, the invention provides improved repeatability and material performance relative to conventional manufacturing approaches.

In one aspect, the invention provides a hybrid manufacturing method that includes preselecting one or more AM process parameters and one or more CM process parameters, depositing a fiber-reinforced thermoplastic material within a mold cavity to form a composite preform, and acquiring process measurement data during formation of the composite preform. The acquired process measurement data is compared with predicted values associated with fiber orientation, porosity, or both, as generated by a numerical model. Based on this comparison, at least one of the AM process parameters or CM process parameters is modified, optionally in situ, to reduce deviations between an actual and a predicted microstructural state. The composite preform is then compression molded under heat and pressure using the modified processing parameters to form a consolidated composite article having tailored microstructural characteristics.

In another aspect, the invention provides a predictive modeling embodiment in which process parameters are refined prior to fabrication rather than through in situ control. In this embodiment, preselected AM and CM process parameters are provided as inputs to a computational fluid dynamics (CFD) model that simulates material flow, thermal behavior, and fiber orientation evolution during formation of a composite preform. The predicted microstructural data generated by the CFD model is then provided to a finite element analysis (FEA) model to predict material properties of a consolidated composite article and refine the AM and CM process parameters. A composite article is subsequently manufactured according to the refined process parameters to manufacture a consolidated composite article with excellent material properties.

In laboratory testing, predictive modeling demonstrated a correlation of greater than 80% between analytically predicted material properties and experimentally measured properties of the finished composite articles. This level of correlation validates the coupled CFD- FEA workflow and enables refinement of AM and CM process parameters prior to subsequent manufacturing runs. Collectively, the disclosed embodiments provide a flexible framework for process optimization, microstructural control, and performance prediction in hybrid additive manufacturing-compression molding processes, either with or without real-time process feedback.

These and other features and advantages of the present invention will become apparent from the following description of the invention, when viewed in accordance with the accompanying drawings and appended claims.

### BRIEF DESCRIPTION OF THE FIGURES

FIG. 1 illustrates a flow chart for a hybrid manufacturing method with in situ control of deposition process parameters and/or molding process parameters.

FIG. 2 illustrates the additive deposition of a fiber-reinforced material into a mold cavity in accordance with the embodiment of FIG. 1.

FIG. 3 illustrates a mold cavity containing a composite preform prior to compression molding.

FIG. 4 illustrates a compression molding sequence under heat and pressure to achieve improved part geometry, consolidation quality, and microstructural characteristics.

FIG. 5 illustrates a predictive modeling workflow for refining deposition process parameters and/or molding process parameters in accordance with a further embodiment.

### DETAILED DESCRIPTION OF THE CURRENT EMBODIMENTS

The invention as disclosed herein includes methods for manufacturing a composite article according to a hybrid AM and CM process. The methods can be used to refine process parameters in situ (Part I below) or as a predictive modeling workflow (Part II below).

### I. In Situ Control of Process Parameters

In general terms, a hybrid manufacturing method for in situ control of process parameters includes: (a) preselecting one or more AM process parameters and one or more CM process parameters according to a hybrid manufacturing process; (b) depositing a fiber-reinforced thermoplastic material within a mold cavity to form a composite preform; (c) acquiring process measurement data during formation of the composite preform; (d) comparing the acquired process measurement data with predicted values associated with fiber orientation and/or porosity; (e) modifying at least one AM process parameter and/or CM process parameter; and (f) compression molding the composite preform under heat and pressure to form a consolidated composite article.

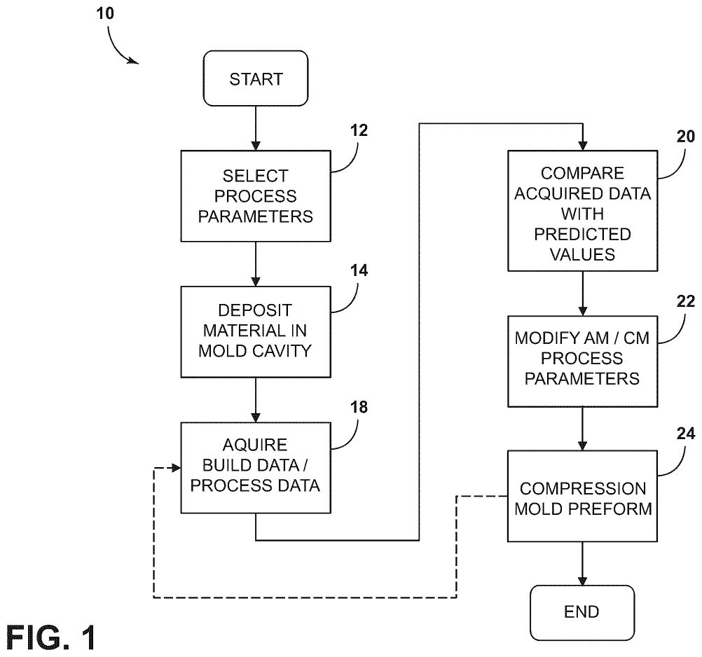

Referring to FIG. 1, a simplified flow diagram illustrating the foregoing method is illustrated and generally designated 10. Initial process parameters are preselected at step 12, including at least one AM process parameter and at least one CM process parameter. An AM process parameter can include, for example, toolpath geometry, extrusion rate, nozzle diameter, or deposition temperature. A CM process parameter can include, for example, platen velocity, compression pressure, or mold temperature. The foregoing process parameters are not exclusive, as other process parameters can be used in other embodiments.

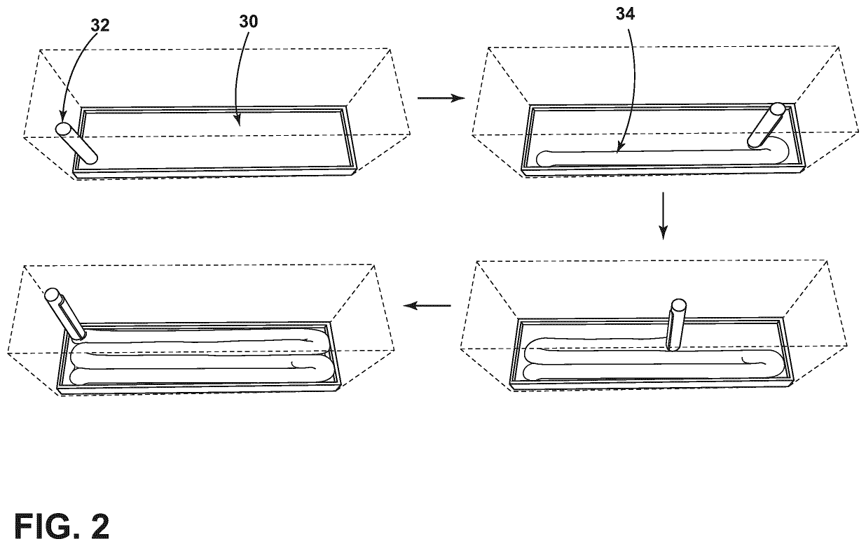

At step 14, the method includes depositing a fiber-reinforced thermoplastic material within a mold cavity to form a composite preform. This step can include additively delivering a molten or softened thermoplastic matrix containing reinforcing fibers into a mold cavity. As illustrated in FIG. 2, the mold cavity 30 defines at least a portion of the geometry of a composite preform and receives the deposited material from a deposition nozzle 32. The deposition nozzle 32 is movable relative to the mold cavity 30 and is configured to dispense the fiber-reinforced thermoplastic material directly onto a surface of the mold cavity 30 or onto the previously-deposited material. The deposition is performed according to a predefined toolpath. The toolpath may be linear, curved, serpentine, and/or multi-directional. As the bead 34 of material exits the nozzle 32, shear forces and flow conditions within the nozzle 32 influence the orientation of reinforcing fibers within the thermoplastic matrix.

In the embodiment of FIG. 2, the step of depositing a fiber-reinforced thermoplastic material is performed while the mold cavity is maintained at a controlled temperature to promote adhesion between successive layers and to manage cooling and solidification of the fiber-reinforced thermoplastic material. The distance between the deposition nozzle and the mold surface, the extrusion rate, and the relative motion of the nozzle are controlled in accordance with the preselected AM process parameters. The fiber-reinforced thermoplastic material is deposited until a desired volume of material is placed within the mold cavity 30, thereby forming the composite preform prior to compression molding.

The resulting composite preform includes one or more deposited beads 34 that collectively occupy a portion or substantially all of the mold cavity volume. The composite preform retains the fiber orientation, bead interfaces, and thermal state imparted during deposition. These characteristics define an initial microstructural state of the composite preform that is subsequently evaluated using acquired process measurement data and compared with predicted values associated with fiber orientation or porosity, as described below.

Referring again to FIG. 1, the method includes acquiring process measurement data during formation of the composite preform at step 18. The process measurement data is indicative of an actual state of the composite preform as the fiber-reinforced thermoplastic material is being deposited within the mold cavity. The acquisition of process measurement data may occur continuously, intermittently, or at predetermined intervals during the deposition step, and may occur prior to completion of the composite preform. The process measurement data can include, by non-limiting example, data associated with thermal conditions, material deposition behavior, and/or geometric characteristics of the composite preform. By way of example and without limitation, the process measurement data may include: temperature data associated with the deposited material, the mold cavity, or the surrounding environment; data associated with bead geometry, deposition rate, or material flow; and/or data indicative of the evolving shape or volume of the composite preform within the mold cavity. The process measurement data may be acquired using one or more sensors positioned proximate to or within the mold cavity, integrated with the additive manufacturing device, or otherwise configured to monitor the deposition process.

In the current embodiment, the process measurement data represents the actual state of the composite preform and is suitable for comparison with predicted values associated with microstructural characteristics, including fiber orientation and porosity. The process measurement data enables detection of deviations between predicted and actual process states and supports subsequent modification of one or more AM processing parameters or CM processing parameters.

The method then includes, at step 20, comparing the acquired process measurement data with predicted values associated with the preform's fiber orientation, porosity, or both. The predicted values are generated using the numerical model and represent one or more of material flow, thermal behavior, and fiber orientation during formation of the composite preform. The comparison step can be performed continuously or at discrete intervals during formation of the composite preform. The comparison(s) can include determining differences between: (a) measured and predicted temperature distributions; (b) measured and predicted bead geometry; (c) measured and predicted deposition behavior; and/or (d) other process-state variables that are correlated with fiber orientation and/or porosity of the composite preform. The results of the comparison provide an indication of whether the composite preform is forming in accordance with the predicted microstructural characteristics and are used to inform subsequent modification of one or more AM or CM processing parameters, optionally in situ and in real time.

The method further includes, at step 22, modifying one or more of the preselected AM process parameters and/or CM process parameters based on the foregoing comparison. In general terms, this step is performed in response to a detected deviation between an actual state of the composite preform and a predicted or target microstructural state. The modification may occur during formation of the composite preform, after completion of the deposition step and prior to compression molding, or both. When the modification is applied to an additive manufacturing processing parameter, the modification may include adjusting, by way of example and without limitation, a toolpath, an extrusion rate, a nozzle velocity, a deposition temperature, a nozzle-to-surface distance, or a bead spacing. When the modification is applied to a compression molding processing parameter, the modification may include adjusting a compression timing, a platen velocity, a compression pressure, a mold temperature, or a dwell time.

Consistent with closed loop control systems, the modification reduces a deviation between the actual and predicted microstructural states. The adjusted processing parameter(s) may be selected to influence material flow, fiber mobility, or consolidation behavior in a manner that promotes formation of a composite preform and a consolidated composite article having fiber orientation or porosity closer to the predicted or target values. By adaptively adjusting one or more AM or CM processing parameters based on the comparison, the method compensates for variations in material properties, environmental conditions, or process disturbances, thereby improving repeatability and consistency of microstructural characteristics in the resulting composite article.

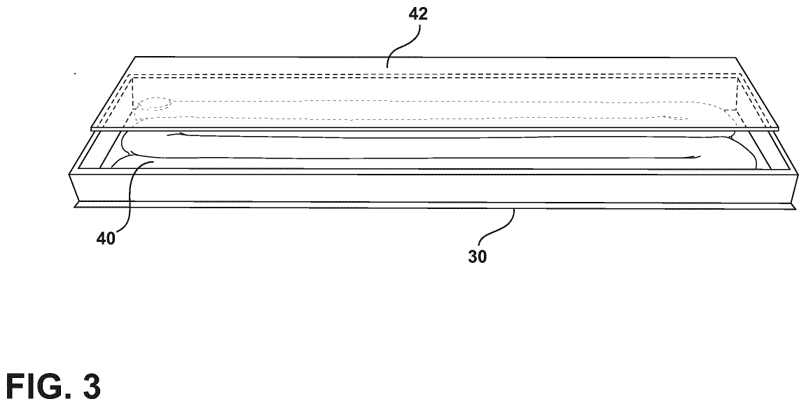

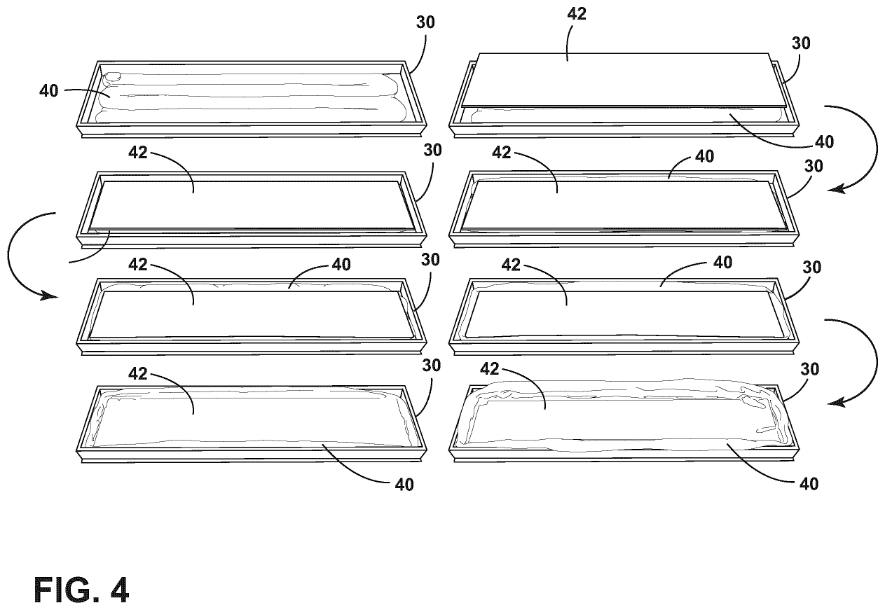

Lastly, at step 24, the method includes compression molding the composite preform within the mold cavity under heat and pressure to form a consolidated composite article. In the current embodiment, and as illustrated in FIGS. 3-4, the composite preform 40 remains positioned within the mold cavity and is subjected to a compression molding operation following modification of at least one additive manufacturing processing parameter and/or compression molding processing parameter. The compression molding step includes the application of pressure to the composite preform using a movable mold component, such as a platen 42, while simultaneously applying thermal energy to the mold cavity. The applied heat softens or maintains the thermoplastic matrix in a flowable or deformable state, while the applied pressure causes the material to flow within the mold cavity. This flow promotes consolidation of the deposited material, reduction of voids, and bonding between adjacent deposited beads. The mold cavity defines the final geometry of the consolidated composite article.

To reiterate, the compression molding operation is performed using one or more CM processing parameters, including compression pressure, platen velocity, mold temperature, or dwell time. At least one of these CM processing parameters may have been modified based on the comparison between acquired process measurement data and predicted values associated with fiber orientation or porosity. Upon completion of the compression molding step, the composite preform is transformed into a consolidated composite article having a reduced porosity and an improved fiber orientation that are influenced by both the additive manufacturing deposition and the subsequent compression molding operation. The consolidated composite article may then be cooled within the mold cavity or after removal from the mold cavity to solidify the thermoplastic matrix. The resulting composite article exhibits structural integrity and microstructural characteristics tailored through the closed-loop hybrid manufacturing process described above.

### II. Predictive Modeling of Process Parameters

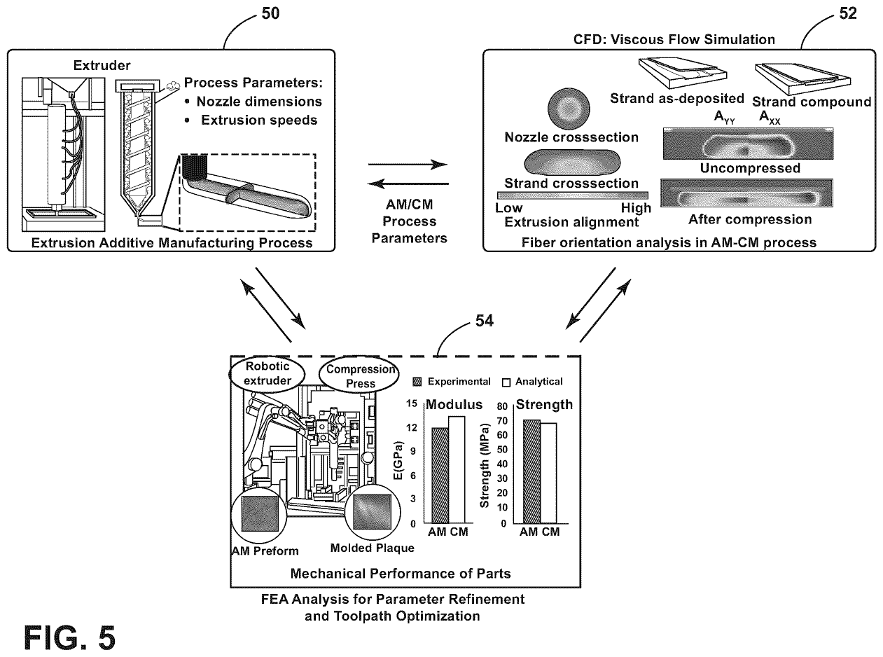

In a further embodiment as shown in FIG. 5, the hybrid manufacturing process is implemented using a predictive modeling workflow that refines process parameters prior to fabrication of a composite article, rather than through in situ process control. In this embodiment, one or more AM process parameters and CM process parameters are preselected according to a hybrid manufacturing process (step 50 in FIG. 5). The preselected process parameters are used as inputs to a computational fluid dynamics (CFD) model that simulates material flow, thermal behavior, and fiber orientation evolution during formation of the composite preform.

The CFD model is executed to generate predicted microstructural data associated with the composite preform (step 52 in FIG. 5). The microstructural data includes spatially resolved fiber orientation distributions, temperature fields, and material flow characteristics. The predicted microstructural data produced by the CFD model are then provided as input to a finite element analysis (FEA) model. The FEA model uses the CFD-derived microstructural data to predict material properties of a consolidated composite article, including mechanical, thermal, or structural properties such as stiffness, strength, or anisotropic behavior (step 54 in FIG. 5). In this manner, the coupled CFD-FEA workflow provides an analytical prediction of material performance based on the preselected process parameters.

Following completion of the analytical modeling, a composite article is manufactured according to the same preselected additive manufacturing and compression molding processing parameters used in the CFD and FEA models. The finished composite article is then evaluated using one or more experimental characterization techniques to measure material properties corresponding to those predicted by the FEA model. The experimentally measured material properties are compared with the analytically predicted material properties to assess the accuracy of the predictive modeling workflow. In laboratory testing, the analytical predictions and the experimentally measured properties demonstrated a correlation of greater than 80 percent. This level of correlation validates the predictive capability of the coupled CFD-FEA modeling approach and enables refinement of the preselected process parameters prior to subsequent manufacturing runs. By iteratively adjusting process parameters based on predictive modeling results and post-build validation, this embodiment supports process optimization without requiring real-time sensing or in situ parameter modification during part fabrication.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims.

1. A method of manufacturing a composite article, comprising:
preselecting an additive manufacturing process parameter and a compression molding process parameter according to a hybrid manufacturing process;
depositing a fiber-reinforced thermoplastic material within a mold cavity according to the preselected additive manufacturing process parameter to form a composite preform;
acquiring process measurement data during or after formation of the composite preform, the process measurement data being indicative of an actual state of the composite preform;
comparing the acquired process measurement data with a predicted value associated with fiber orientation or porosity of the composite preform;
modifying, based on the comparison, at least one of the preselected additive manufacturing process parameter or the preselected compression molding process parameter; and
compression molding the composite preform within the mold cavity under heat and pressure using the modified process parameter to form a consolidated composite article.

2. The method of claim 1, wherein the additive manufacturing process parameter includes material flow rate, print speed, nozzle geometry, nozzle-to-substrate gap height, or material extrusion temperature.

3. The method of claim 1, wherein the compression molding process parameter includes at least one of compression pressure, mold temperature, and compression timing after deposition.

4. The method of claim 1, wherein the acquired process measurement data includes temperature data, deposition geometry data, material flow data, or a combination thereof.

5. The method of claim 1, wherein the predicted value is generated using a numerical model representing material flow, thermal behavior, fiber orientation, or a combination thereof.

6. The method of claim 1, wherein comparing the acquired process measurement data with the predicted value includes determining a deviation between a measured process-state variable and a predicted process-state variable correlated with fiber orientation or porosity.

7. The method of claim 1, wherein modifying the preselected additive manufacturing process parameter includes adjusting a toolpath, an extrusion rate, a nozzle velocity, a deposition temperature, a nozzle-to-surface distance, or bead spacing.

8. The method of claim 1, wherein modifying the preselected compression molding process parameter includes adjusting compression timing, platen velocity, compression pressure, mold temperature, or dwell time.

9. The method of claim 1, wherein the modification occurs during formation of the composite preform, after formation of the composite preform, or both.

10. The method of claim 1, wherein the process measurement data is acquired continuously, intermittently, or at predetermined intervals during formation of the composite preform.

11. A method of refining process parameters for manufacturing a composite article, the method comprising:
preselecting at least one additive manufacturing process parameter and at least one compression molding parameter according to a hybrid manufacturing process;
executing a computational fluid dynamics model using the preselected process parameters to predict microstructural characteristics of a composite preform, the microstructural characteristics including fiber orientation and porosity;
providing the predicted microstructural characteristics as an input to a finite element analysis model;
executing the finite element analysis model to predict material properties of a consolidated composite article using the preselected process parameters;
adjusting at least one of the preselected process parameters based on the predicted material properties; and
depositing a fiber-reinforced thermoplastic material within a mold cavity to form a composite preform and compression molding the composite preform according to the adjusted process parameters to form a consolidated composite article.

12. The method of claim 11, wherein the additive manufacturing process parameter includes material flow rate, print speed, nozzle geometry, nozzle-to-substrate gap height, or material extrusion temperature.

13. The method of claim 11, wherein the compression molding process parameter includes compression pressure, mold temperature, or compression timing after deposition.

14. The method of claim 11, wherein the predicted microstructural characteristics include mechanical, thermal, structural, or anisotropic properties.

15. The method of claim 11, further comprising experimentally measuring material properties of the consolidated composite article.

16. The method of claim 15, further comprising comparing the experimentally measured material properties with the predicted material properties.

17. The method of claim 16, further comprising refining at least one of the process parameters based on the comparison of the experimentally measured material properties with the predicted material properties.

18. The method of claim 17, wherein refining at least one of the process parameters includes adjusting a toolpath, an extrusion rate, a nozzle velocity, a deposition temperature, a nozzle-to-surface distance, or bead spacing.

19. The method of claim 17, wherein refining at least one of the process parameters includes adjusting compression timing, platen velocity, compression pressure, mold temperature, or dwell time.

20. The method of claim 16, wherein refining at least one of the process parameters is performed prior to a subsequent manufacturing run.
